(19) United States
(12) Patent Application Publication
(10) Pub. No.: US 2026/0269502 A1
(43) Pub. Date: Sep. 10, 2026

(54) CONNECTOR, CONNECTOR ASSEMBLY, AND METHOD FOR MANUFACTURING CONNECTOR

(71) Applicant: HIROSE ELECTRIC CO., LTD., Kanagawa (JP)

(72) Inventors: Geunho LEE, Kanagawa (JP); Yuki KOBAYASHI, Kanagawa (JP)

(21) Appl. No.: 19/554,784

(22) Filed: Mar. 3, 2026

(30) Foreign Application Priority Data
Mar. 10, 2025 (JP) 2025-037084

(51) Int. Cl. H01R 13/40; H01R 43/24

(52) U.S. Cl. CPC H01R 13/40; H01R 43/24

(57) ABSTRACT

Provided is a connector including: a housing; and a plurality of terminals arranged in a terminal arrangement direction intersecting a connection direction with a mating connector, each of the terminals has an extension portion extending in the connection direction, the extension portion has a first surface facing outward, and a second surface facing the first surface, at least a part of the first surface is exposed to the outside of the housing in a first predetermined range in the connection direction, at least a part of the extension portion other than the exposed first surface is mounted to the housing by insert molding, and a plurality of through holes or a plurality of recesses are provided between the extension portions adjacent to each other in the terminal arrangement direction in a second predetermined range included in the first predetermined range, and extend into the inside of the housing.

### CROSS-REFERENCE TO RELATED APPLICATION

This application claims priority from Japanese Patent Application No. 2025-037084 filed with the Japan Patent Office on Mar. 10, 2025, the entire content of which is hereby incorporated by reference.

### BACKGROUND

### 1. Technical Field

The present disclosure relates to a connector, a connector assembly, and a method for manufacturing a connector.

### 2. Related Art

Manufacturing of a connector by insert molding is generally known to be performed as follows. First, a plurality of strip-shaped metal materials formed as terminals are prepared in a state of being connected to a carrier, and a mold is installed for the plurality of strip-shaped metal materials. Thereafter, resin is injected into the mold, and the strip-shaped metal materials are separated from the carrier, whereby the connector is manufactured. When injecting the resin into the mold, pressure is applied to the resin in order to spread the resin to every corner of the mold. As a result, the strip-shaped metal materials may move due to a flow of the resin receiving the pressure, and thus, in the connector manufactured by insert molding, a positional deviation may occur in a pitch between the terminals.

In order to solve such a problem, for example, in JP-A-8-31486, resin is injected in a state where one end (engaging portion), the other end (solder tail portion), one surface of an extension portion between the one end and the other end (contact portion), and a part of the other surface of the terminal are supported by the mold. In particular, each terminal is positioned by pressing, with a receiving taper of the mold, a taper provided at the one end (engaging portion) of the terminal.

### SUMMARY

A connector according to an embodiment of the present disclosure includes: a housing; and a plurality of terminals held by the housing, wherein the plurality of terminals are arranged in a terminal arrangement direction intersecting a connection direction with a mating connector, each of the plurality of terminals has one end, has another end on a side opposite to the one end in the connection direction, and has an extension portion extending in the connection direction between the one end and the other end, the extension portion has a first surface extending in the terminal arrangement direction and the connection direction and facing outward, and a second surface facing the first surface, at least a part of the first surface is exposed to the outside of the housing in a first predetermined range in the connection direction, at least a part of the extension portion other than the exposed first surface is mounted to the housing by insert molding, the housing has a plurality of through holes or a plurality of recesses, and the plurality of through holes or the plurality of recesses are provided between the extension portions adjacent to each other in the terminal arrangement direction in a second predetermined range included in the first predetermined range, and extend into the inside of the housing.

### BRIEF DESCRIPTION OF THE DRAWINGS

FIG. 1 is a perspective view of a connector assembly according to an embodiment of the present disclosure.

FIG. 2 is a perspective view of the connector assembly according to the embodiment of the present disclosure.

FIG. 3 is a perspective view of a receptacle connector according to the embodiment of the present disclosure.

FIG. 4 is an exploded perspective view of the receptacle connector.

FIG. 5 is a front view of the receptacle connector.

FIG. 6 is a cross-sectional view taken along line VI-VI of FIG. 5.

FIG. 7 is a perspective view in a cross section taken along line VI-VI of FIG. 5.

FIG. 8 is a cross-sectional view taken along line VII-VII of FIG. 5.

FIG. 9 is a perspective view in a cross section taken along line VII-VII of FIG. 5.

FIG. 10 is a cross-sectional view taken along line X-X of FIG. 5.

FIG. 11 is a cross-sectional view for explaining a method for manufacturing a receptacle connector by insert molding, the view showing a manufacturing process at the same position as the cross section taken along line VI-VI of FIG. 5.

FIG. 12 is a cross-sectional view for explaining the method for manufacturing a receptacle connector by insert molding, the view showing a manufacturing process at the same position as the cross section taken along line VI-VI of FIG. 5.

FIG. 13 is a cross-sectional view for explaining the method for manufacturing a receptacle connector by insert molding, the view showing a manufacturing process at the same position as the cross section taken along line VI-VI of FIG. 5.

FIG. 14 is a cross-sectional view for explaining the method for manufacturing a receptacle connector by insert molding, the view showing a manufacturing process at the same position as the cross section taken along line X-X of FIG. 5.

FIG. 15 is a cross-sectional view for explaining the method for manufacturing a receptacle connector by insert molding, the view showing a manufacturing process at the same position as the cross section taken along line X-X of FIG. 5.

FIG. 16 is a cross-sectional view for explaining the method for manufacturing a receptacle connector by insert molding, the view showing a manufacturing process at the same position as the cross section taken along line X-X of FIG. 5.

FIG. 17 is a front view of a plug connector according to the embodiment of the present disclosure.

FIG. 18 is an exploded perspective view of the plug connector.

FIG. 19 is a cross-sectional view taken along line XIX-XIX of FIG. 17.

FIG. 20 is a perspective view in a cross section taken along line XX-XX of FIG. 17.

FIG. 21 is a cross-sectional view taken along line XX-XX of FIG. 17.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to JP-A-8-31486, the positional deviation of the pitch between the terminals can be suppressed to some extent. However, in JP-A-8-31486, the mold only supports the one end and the other end of the terminal, etc., and since a space between the terminals is not supported, the positional deviation of the pitch between the terminals cannot be sufficiently suppressed. In particular, when a terminal having a long extension portion is used, the positional deviation easily occurs in the pitch between the terminals.

One of the objects of the present disclosure is to solve such a problem and to provide a connector and a connector assembly in which a pitch between terminals in an arrangement direction of a plurality of terminals is accurately defined, and a method for manufacturing the connector.

A connector according to an aspect of the present disclosure includes a housing and a plurality of terminals held by the housing, the plurality of terminals are arranged in a terminal arrangement direction intersecting a connection direction with a mating connector, each of the plurality of terminals has one end, has another end on a side opposite to the one end in the connection direction, and has an extension portion extending in the connection direction between the one end and the other end, the extension portion has a first surface extending in the terminal arrangement direction and the connection direction and facing outward, and a second surface facing the first surface, at least a part of the first surface is exposed to the outside of the housing in a first predetermined range in the connection direction, at least a part of the extension portion other than the exposed first surface is mounted to the housing by insert molding, the housing has a plurality of through holes or a plurality of recesses, and the plurality of through holes or the plurality of recesses are provided between the extension portions adjacent to each other in the terminal arrangement direction in a second predetermined range included in the first predetermined range, and extend into the inside of the housing.

A connector assembly according to an aspect of the present disclosure includes the connector and a mating connector configured to be connectable to the connector.

A method for manufacturing a connector according to an aspect of the present disclosure is a method for manufacturing a connector by insert molding, including: preparing a plurality of strip-shaped metal materials arranged adjacent to each other in a terminal arrangement direction intersecting a connection direction with a mating connector by being connected to a carrier, the plurality of strip-shaped metal materials each having one end, another end provided on a side opposite to the one end in the connection direction, and an extension portion provided between the one end and the other end and extending in the connection direction; inserting a convex portion provided in a first mold between the extension portions in a direction from a first surface facing outward in the extension portion to a second surface facing the first surface; installing a second mold to cover the one end in a direction from the mating connector to the connector; injecting resin into the first mold and the second mold; removing the first mold and the second mold; and separating the plurality of strip-shaped metal materials from the carrier.

According to the connector of the present disclosure, the extension portions can be separated from each other in the terminal arrangement direction by a predetermined distance defined by the through hole or the recess. Furthermore, according to the method for manufacturing a connector of the present disclosure, the connector can be easily manufactured.

According to the present disclosure, a connector and a connector assembly in which a pitch between terminals in an arrangement direction of a plurality of terminals is accurately defined, and a method for manufacturing the connector are provided.

Hereinafter, a connector assembly according to an exemplary embodiment for carrying out the present disclosure will be described in detail with reference to the drawings. However, dimensions, materials, shapes, relative positions of components, and the like described in the following embodiment can be variously changed without departing from the gist of the present disclosure, and can be changed according to a configuration of an apparatus to which the present disclosure is applied or various conditions. Furthermore, the scope of the present disclosure is not limited to the embodiment specifically described below.

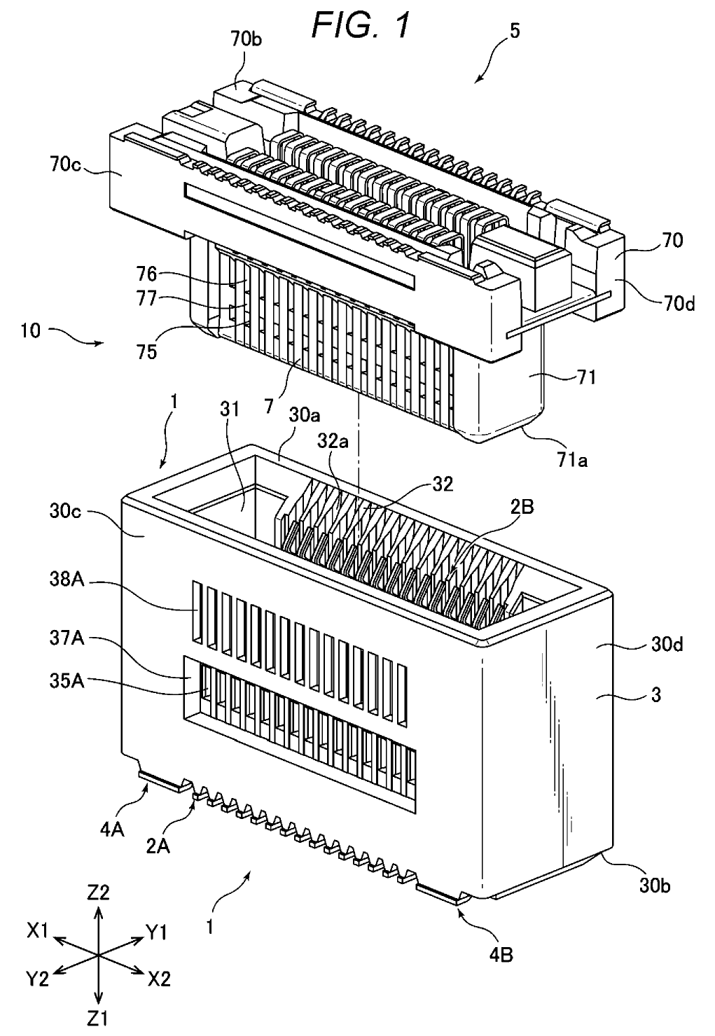

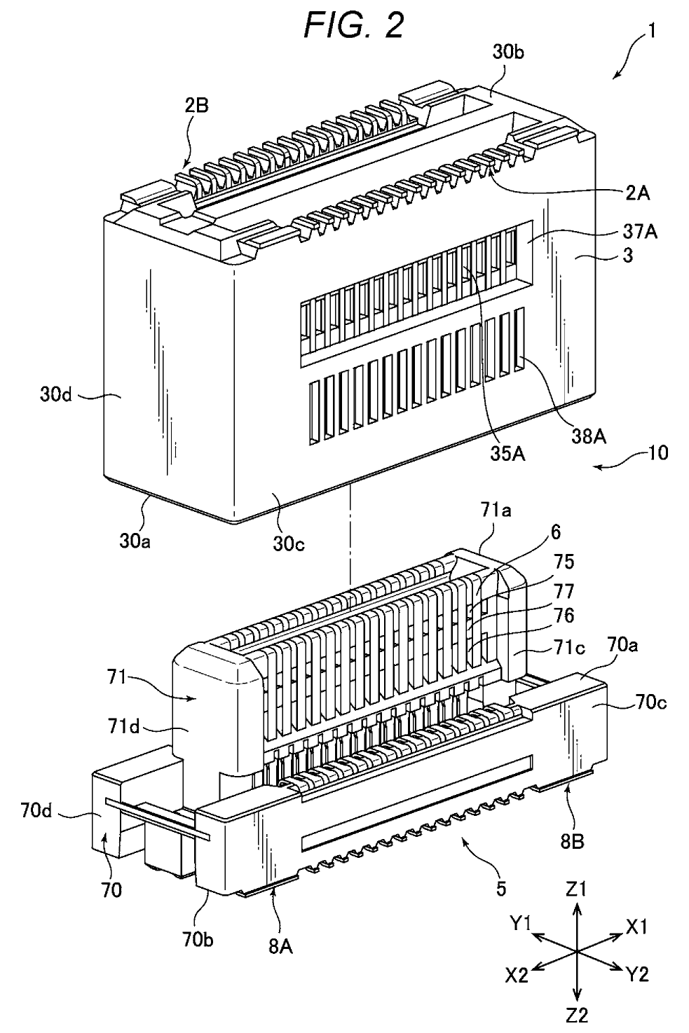

FIGS. 1 and 2 show perspective views of a connector assembly 10 of the present disclosure at angles different from each other. The connector assembly 10 includes a set of a receptacle connector 1 (first connector) and a plug connector 5 (second connector) connectable to the receptacle connector 1. FIGS. 1 and 2 show a state before connecting the receptacle connector 1 and the plug connector 5.

In the following description, the X direction may be described as a terminal arrangement direction, a width direction, or a left-right direction. Furthermore, the Y direction may be described as a depth direction or a front-rear direction. Furthermore, the Z direction may be described as a connection direction (fitting direction) of the receptacle connector 1 and the plug connector 5, an extension direction of the extension portion, or an up-down direction.

The receptacle connector 1 and the plug connector 5 are configured to be mountable on separate substrates (not shown). In order to connect the plug connector 5, the receptacle connector 1 is provided with a fitting hole 31 recessed in a concave shape in the connection direction (Z direction) of the receptacle connector 1 and the plug connector 5. The fitting hole 31 extends to the vicinity of the middle in the Z direction of the receptacle connector 1. The plug connector 5 is provided with a fitting protrusion (movable portion 71) corresponding to the fitting hole 31 and protruding in a convex shape along the connection direction. By fitting the fitting protrusion (movable portion 71) of the plug connector 5 into the fitting hole 31 of the receptacle connector 1, the receptacle connector 1 and the plug connector 5 can be connected. As a result, a plurality of terminals 2 provided in the receptacle connector 1 and a plurality of terminals 6 provided in the plug connector 5 are brought into contact with each other, so that the substrate on which the receptacle connector 1 is mounted and the substrate on which the plug connector 5 is mounted can be electrically connected.

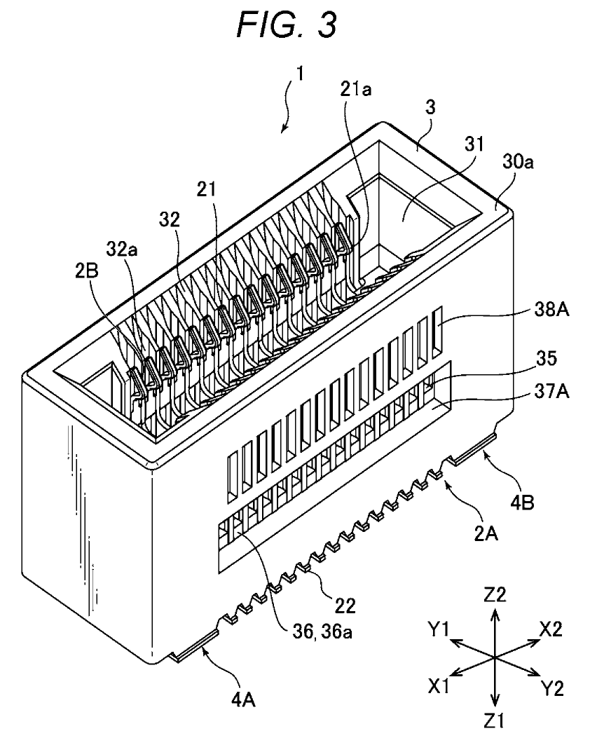

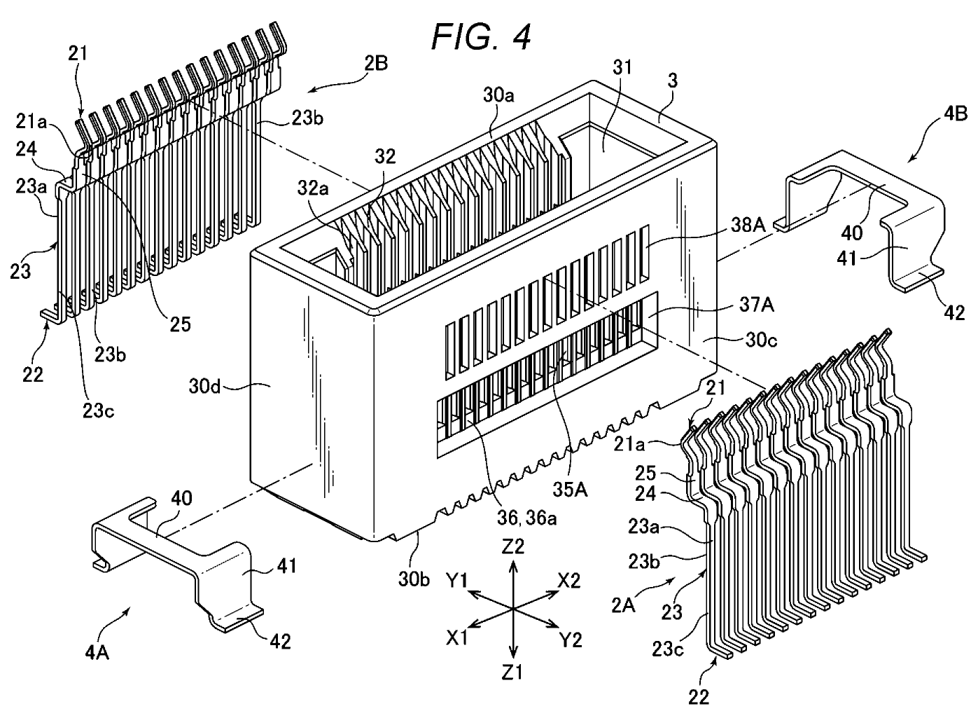

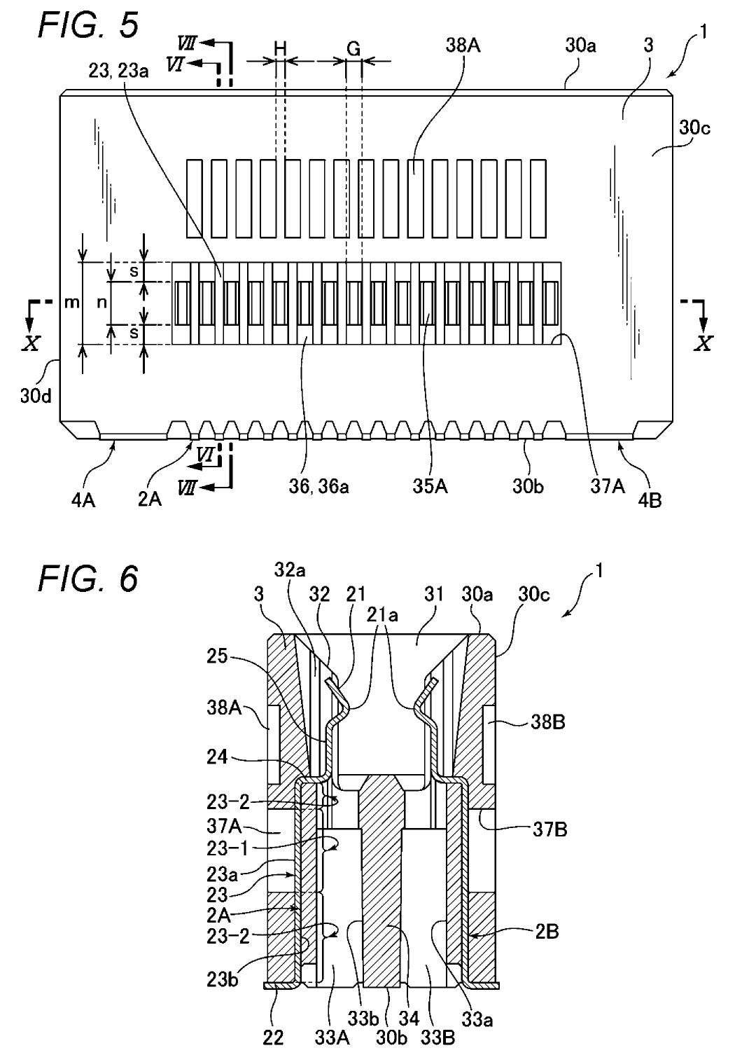

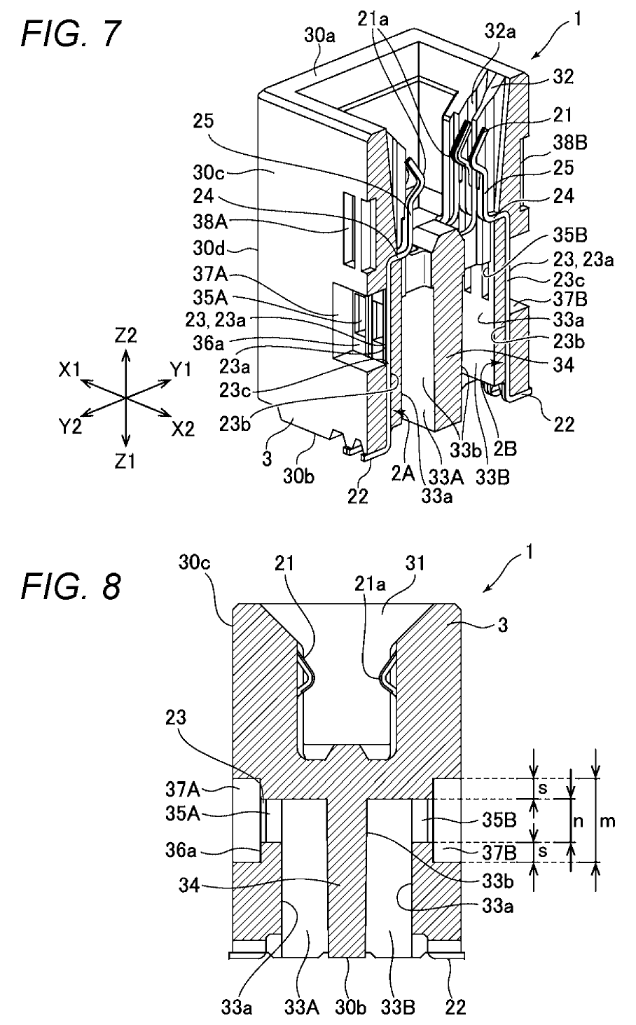

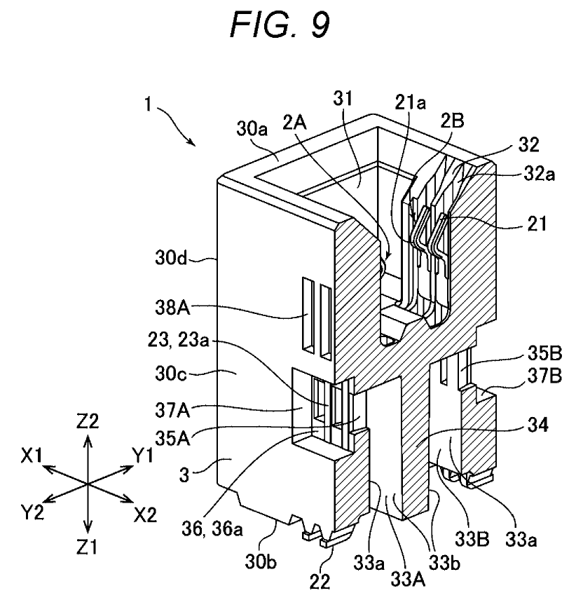

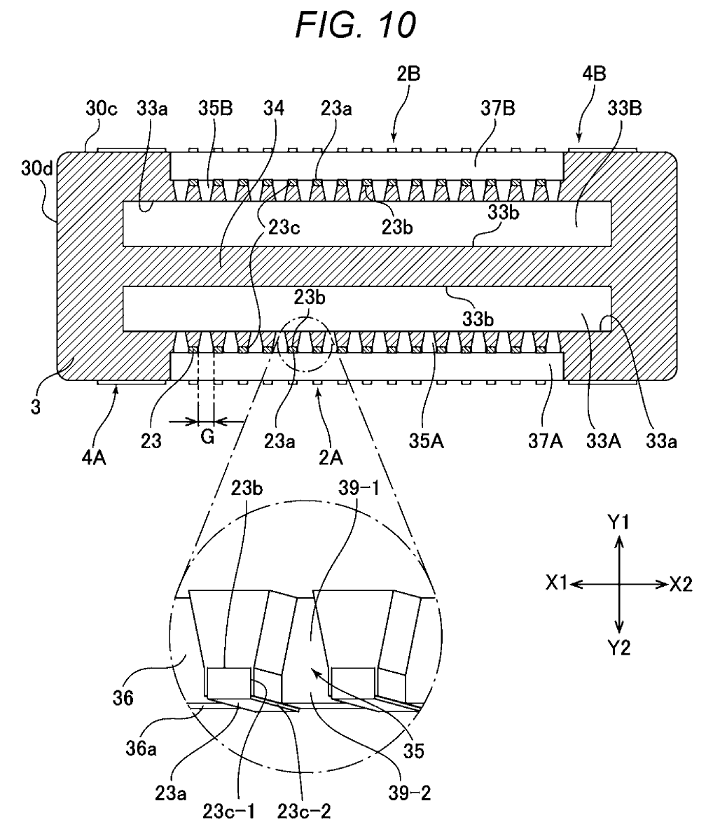

FIG. 3 shows a perspective view of the receptacle connector. FIG. 4 is an exploded perspective view of FIG. 3. Furthermore, FIG. 5 shows a front view of the receptacle connector. FIG. 6 is a cross-sectional view taken along line VI-VI of FIG. 5, and FIG. 7 is a perspective view in a cross section taken along line VI-VI of FIG. 5. FIG. 8 is a cross-sectional view taken along line VII-VII of FIG. 5, and FIG. 9 is a perspective view in a cross section taken along line VII-VII of FIG. 5. FIG. 10 is a cross-sectional view taken along line X-X of FIG. 5.

The receptacle connector 1 has a substantially rectangular shape as a whole, and has a symmetrical shape in each of the X direction and the Y direction. In the following description and drawings, when it is convenient to distinguish between a member on the X1 side (left side) and a member on the X2 side (right side) in the X direction, letters “A” and “B” are added in addition to reference numerals. Furthermore, when it is convenient to distinguish between a member on the Y1 side (front side) and a member on the Y2 side (rear side) in the Y direction, letters “A” and “B” are added in addition to reference numerals.

The receptacle connector 1 includes a resin housing 3, a plurality of terminals 2 mounted (held) to the housing 3 by insert molding, and two fixing metal fittings 4. At least a part of each of the terminal 2 and the fixing metal fitting 4 is mounted to the housing 3 by insert molding. FIG. 4 is a drawing assuming that the terminals 2 and the fixing metal fittings 4 could be removed from the housing 3 for convenience of explanation.

The plurality of terminals 2 all have the same shape and structure, and are arranged adjacent to each other with the X direction as the terminal arrangement direction. As will be described later, the plurality of terminals 2 are formed by punching and bending a single metal plate. In the following description, the terminal arrangement direction may be referred to as an arrangement direction.

The plurality of terminals 2 arranged adjacent to each other along the X direction constitute a terminal group. In the illustrated example, two such terminal groups are provided while being separated from each other in the Y direction. A gap formed between these two terminal groups can form a part of the fitting hole 31 into which the fitting protrusion (movable portion 71) of the plug connector 5 is fitted. Note that the number of terminal groups does not have to be two, and one or three or more terminal groups may be provided.

The terminal 2 extends in the Z direction, which is the connection direction, as a whole. A contact portion 21 is provided at an end portion on the Z2 side of the terminal 2. Furthermore, a mounting portion 22 is provided at an end portion on the Z1 side of the terminal 2. That is, the contact portion 21 capable of being brought into contact with the terminal 6 of the plug connector 5 is provided at one end in the Z direction of the terminal 2, and the mounting portion 22 fixed to the housing 3 is provided at the other end.

The contact portion 21 is not mounted to the housing 3, and is formed as a free end while being elastically deformable in the Y direction. The vicinity of the middle of the contact portion 21 is bent so as to slightly protrude in a direction toward the inside of the fitting hole 31 in the Y direction, and a tip of the protruding portion forms a contact point 21a.

The mounting portion 22 is a portion mounted on the substrate, and extends in parallel with the substrate along the Y direction toward the outside of the housing 3. The mounting portion 22 has a lower surface on the Z1 side (substrate side), has side surfaces on the X1 side and the X2 side, and has an end surface on the outside.

Between the contact portion 21 and the mounting portion 22, a leg portion 23 (extension portion), a horizontal portion 24, and a vertical portion 25 are provided in this order from the Z1 side toward the Z2 side.

The leg portion 23 is a relatively long portion located between the mounting portion 22 and the horizontal portion 24, and extends linearly along the Z direction. In the present embodiment, the extension direction of the leg portion 23 coincides with the Z direction, which is the connection direction, but the extension direction in which the leg portion 23 extends does not have to coincide with the Z direction.

The horizontal portion 24 is a portion located between the leg portion 23 and the vertical portion 25, and extends horizontally along the Y direction from the leg portion 23 toward the inside of the fitting hole 31 in a state where an end portion of the leg portion 23 on the Z2 side (an end portion of the leg portion 23 on the side opposite to the mounting portion 22) is bent at a substantially right angle.

The vertical portion 25 is a portion located between the horizontal portion 24 and the contact portion 21, and extends vertically in the Z direction in a state where an end portion of the horizontal portion 24 on the side opposite to the leg portion 23 in the Y direction is bent at a substantially right angle.

At least a part of each of the leg portion 23, the horizontal portion 24, and the vertical portion 25 is mounted to the housing 3 together with the mounting portion 22.

Like the terminal 2, the fixing metal fitting 4 is formed by punching and bending a metal plate, and includes a base portion 40, a leg portion 41, and a mounting portion 42.

The base portion 40 of the fixing metal fitting 4 is a portion extending horizontally along the Y direction. Since the base portion 40 is provided inside the housing 3, the base portion 40 cannot actually be seen from the outside.

The leg portion 41 of the fixing metal fitting 4 extends vertically along the Z direction and is formed by bending each of both ends of the base portion 40 at a substantially right angle. Since the leg portion 41 is provided inside the housing 3 like the base portion 40, the leg portion 41 cannot actually be seen from the outside.

The mounting portion 42 of the fixing metal fitting 4 is a plate-like portion formed by bending an end portion of the leg portion 41. Unlike the base portion 40 and the leg portion 41, the mounting portion 42 is provided while being exposed to the outside of the housing 3, and extends in parallel with the substrate along the Y direction toward the outside of the housing 3.

The housing 3 includes a fitting surface 30a, a bottom surface 30b, a side surface 30c, and a side surface 30d. The fitting surface 30a forms an entrance of the fitting hole 31. The bottom surface 30b is an end surface located on the opposite side of the fitting surface 30a in the Z direction. The side surface 30c is a side surface extending in the X direction and the Z direction, and the side surface 30d is a side surface extending in the Y direction and the Z direction. In the present embodiment, the direction in which the side surface 30c extends coincides with the X direction, which is the arrangement direction of the terminals 2, but the direction in which the side surface 30c extends does not have to coincide with the X direction.

The fitting surface 30a is provided with the entrance of the fitting hole 31. A wall surface of the fitting hole 31 is provided with a plurality of walls 32 protruding toward the inside of the fitting hole 31 along the Y direction. A groove 32a along the Z direction is formed between the walls 32 adjacent to each other in the X direction. Each terminal 2 is installed in one of the grooves 32a.

On the bottom surface 30b, the mounting portion 22 of the terminal 2 and the mounting portion 42 of the fixing metal fitting 4 are provided while being exposed to the outside. The receptacle connector 1 is mounted on the substrate through the mounting portion 22 and the mounting portion 42.

The side surface 30c is provided with one recess 37 extending along the X direction and a plurality of recesses 38 arranged along the X direction.

The plurality of recesses 38 extend along the Z direction while being separated from each other by a predetermined distance H in the X direction. The plurality of recesses 38 are provided to reduce the amount of resin used for the housing 3.

The leg portion 23 has a first surface 23a, which is a surface extending in the X direction and the Z direction, and a second surface 23b facing the first surface 23a in the Y direction. The first surface 23a is an outer surface in the Y direction among X-Z surfaces of the leg portion 23. The second surface 23b is an inner surface in the Y direction among the X-Z surfaces of the leg portion 23. That is, the first surface 23a faces the outside of the receptacle connector 1 (housing 3), and the second surface 23b faces the inside of the receptacle connector 1 (housing 3).

Inside the recess 37, a leg portion part 23-1, which is a part of the leg portion 23, is provided while being exposed to the outside of the housing 3. The leg portion part 23-1 extends over a predetermined range m (first predetermined range) (see FIG. 5, FIG. 8, etc.) along the Z direction. The first surface 23a of the leg portion part 23-1 is exposed to the outside in the predetermined range m.

That is, at least a part of the first surface 23a of the leg portion 23 is exposed to the outside of the housing 3 in the range m in the Z direction. Furthermore, at least a part of the leg portion 23 other than the exposed first surface 23a is mounted to the housing 3 by insert molding.

The first surface 23a is formed in the same plane as the first surface 23a of the leg portion part 23-1 adjacent in the X direction. Furthermore, all the first surfaces 23a of the plurality of leg portion parts 23-1 exposed to the outside are formed in the same X-Z plane (at the same position in the Y direction).

Furthermore, the first surface 23a is provided while slightly protruding outward in a direction from the second surface 23b toward the first surface 23a with respect to a surface 36a of an exposed portion 36 of the housing 3 adjacent to the leg portion 23 in the X direction. That is, the first surface 23a is located outside in the Y direction with respect to the surface 36a of the housing 3 adjacent to the leg portion 23 in the X direction.

A plurality of through holes 35 are provided between the leg portion parts 23-1 adjacent to each other in the X direction. The through hole 35 has a length over a predetermined range n (second predetermined range) (see FIG. 5, FIG. 8, etc.) included in the range m along the Z direction. The through hole 35 extends into the inside of the housing 3 along the Y direction from the exposed first surface 23a side toward the second surface 23b side.

In the present embodiment, the range n is set smaller than the range m, but the range n may be the same size as the range m. However, by setting the range n smaller than the range m, the mold removal work can be facilitated when providing the through hole 35.

Furthermore, in the present embodiment, the direction in which the through hole 35 penetrates is the direction along the Y direction, which is the depth direction, but the penetration direction of the through hole 35 does not have to be the direction along the Y direction.

The leg portion parts 23-1 are separated from each other by a predetermined distance G defined by the plurality of through holes 35 in the X direction. Furthermore, the entire terminals 2 having the leg portion parts 23-1 are also separated from each other by the predetermined distance G defined by the plurality of through holes 35 in the X direction. As a result, the receptacle connector 1 in which the deviation of the pitch between the terminals is suppressed can be configured.

Note that the through hole 35 may be a recess (bottomed hole, concave portion) recessed inward instead of a hole. In that case, the receptacle connector 1 has the through hole 35 (hole) or the recess between the leg portions 23 of the terminals 2 adjacent to each other in the terminal arrangement direction, so that the adjacent leg portions 23 are configured to be separated from each other by the predetermined distance G defined by the length of the through hole 35 or the recess in the terminal arrangement direction (width in the X direction).

The predetermined distance G is preferably set to be slightly longer than the length of the through hole 35 or the recess in the terminal arrangement direction (opening length of the through hole 35 or the recess). In other words, the length of the through hole 35 or the recess in the terminal arrangement direction (opening length of the through hole 35 or the recess) is preferably set to be slightly shorter than the predetermined distance G. By setting in this way, it becomes possible to easily mount the side surface 23c of the leg portion 23 to the housing 3 (see FIG. 10, etc.). Furthermore, the leg portions 23 adjacent to each other in the terminal arrangement direction can be arranged so as to be separated from each other by a predetermined distance longer than the length of the through hole 35 or the recess in the terminal arrangement direction.

At least a part of a cross section (X-Z plane) of the through hole 35 intersecting the Y direction is preferably set to gradually and/or stepwise decrease as it goes into the inside of the housing 3 from the first surface 23a side toward the second surface 23b side. With such a configuration, the mold removal work can be facilitated. In the present embodiment, on the inner side of the housing 3, the dimension of the through hole 35 in the X direction is set to gradually decrease as it goes into the inside of the housing 3. As a result, the shape of a cross-sectional portion 39-1 of the through hole 35 in the X-Y plane intersecting the Z direction is substantially trapezoidal as shown in the partially enlarged view of FIG. 10. On the other hand, in the thickness portion of the terminal 2 on the exposed side (first surface 23a side) of the housing 3, such a structure is not adopted, and the shape of a cross-sectional portion 39-2 of the through hole 35 in the X-Y plane is substantially rectangular. Although not particularly shown, the dimension of the through hole 35 in the Z direction, not in the X direction, may be set to gradually and/or stepwise decrease as it goes into the inside of the housing 3.

A portion over the range n in the leg portion part 23-1 is mounted to the housing 3 on the second surface 23b of the leg portion 23. Furthermore, the portion over the range n in the leg portion part 23-1 is mounted to the housing 3 at at least a portion 23c-1 of the side surface 23c of the leg portion 23. The portion 23c-1 is a portion of the side surface 23c on the second surface 23b side. In other words, the second surface 23b of the leg portion 23 is mounted to the housing 3 at least in the range n (second predetermined range). Furthermore, at least a portion of the side surface 23c on the second surface 23b side is mounted to the housing 3 at least in the range n (second predetermined range).

On the other hand, a portion 23c-2 of the side surface 23c on the first surface 23a side in the Y direction may be in a state where the resin of the housing 3 is thinner than the portion 23c-1 due to the relationship with the cross section (X-Z plane) of the through hole 35. Alternatively, the portion 23c-2 may be exposed to the outside. However, even in such a case, since the first surface 23a other than the range m is covered with the housing 3, the leg portion 23 can be supported (held) by the resin of the housing 3.

Furthermore, a portion other than the portion over the range n in the leg portion part 23-1, that is, a portion over a range s is mounted to the housing 3 on the second surface 23b and the side surface 23c.

The range s is a range within the range m (within the first predetermined range) and outside the range n (outside the second predetermined range). That is, the second surface 23b and the side surface 23c are mounted to the housing 3 in the range s.

Furthermore, a portion other than the leg portion part 23-1 in the leg portion 23, that is, a leg portion part 23-2 is mounted to the housing 3 on the first surface 23a, the second surface 23b, and the side surface 23c.

Note that the leg portion part 23-2 may be mounted to the housing 3 on the first surface 23a, or may be mounted to the housing 3 on the second surface 23b and the side surface 23c.

The leg portion part 23-2 is a portion outside the range m (outside the first predetermined range) in the leg portion 23. That is, at least a part of the first surface 23a may be mounted to the housing 3 outside the range m, or at least a part of the second surface 23b and at least a part of the side surface 23c may be mounted to the housing 3 outside the range m.

The housing 3 is provided with two spaces 33A and 33B on the side opposite to the fitting hole 31 in the Z direction. These spaces 33A and 33B extend from the bottom surface 30b of the housing 3 on the Z1 side toward the Z2 side, which is the plug connector 5 side, that is, toward the inside of the housing 3, to the vicinity of the middle of the receptacle connector 1. The spaces 33A and 33B are separated by a partition wall 34 arranged at the center in the Y direction and extending along the X direction. Inside the housing 3, the spaces 33A and 33B communicate with the through holes 35A and 35B, respectively.

At least a part of a cross section (X-Y plane) of the spaces 33A and 33B intersecting the Z direction is preferably set to gradually and/or stepwise decrease as it goes from the bottom surface 30b of the housing 3 toward the plug connector 5 side (Z2 side), that is, toward the inside of the housing 3. In the present embodiment, a surface 33b of the partition wall 34 constituting a cross section (Y-Z plane) intersecting the X direction is inclined so as to approach the side of a surface 33a of the housing 3 mounted to the second surface 23b of the leg portion 23 from the bottom surface 30b of the housing 3 toward the plug connector 5 side (Z2 side). With such a configuration, the mold removal work can be facilitated.

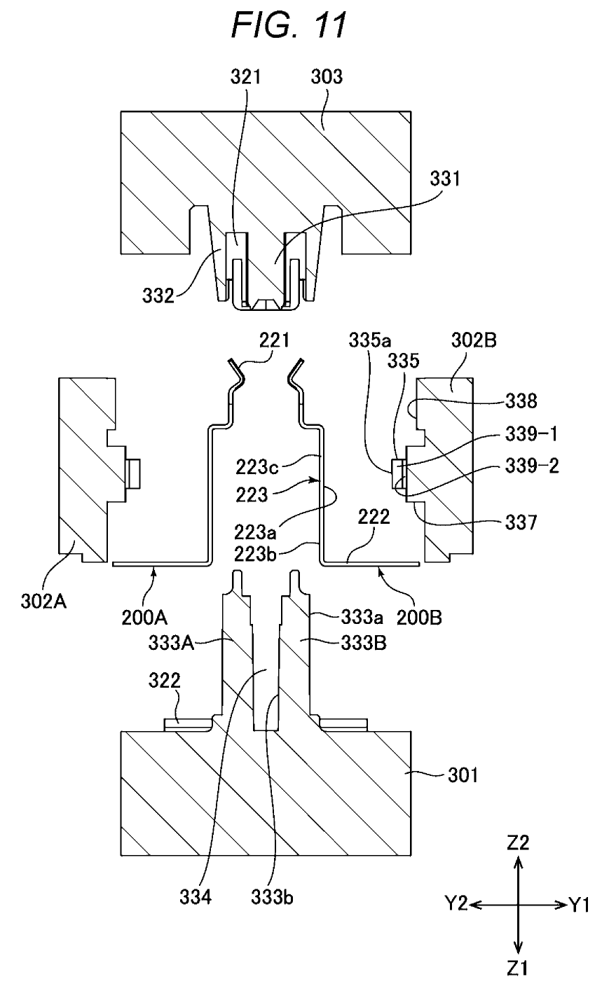

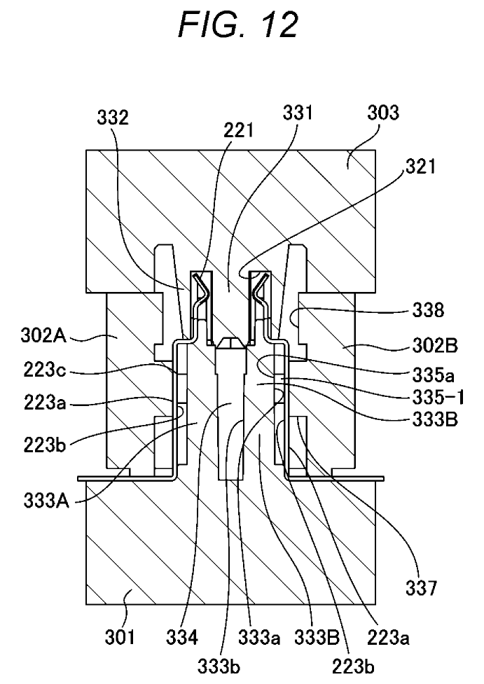

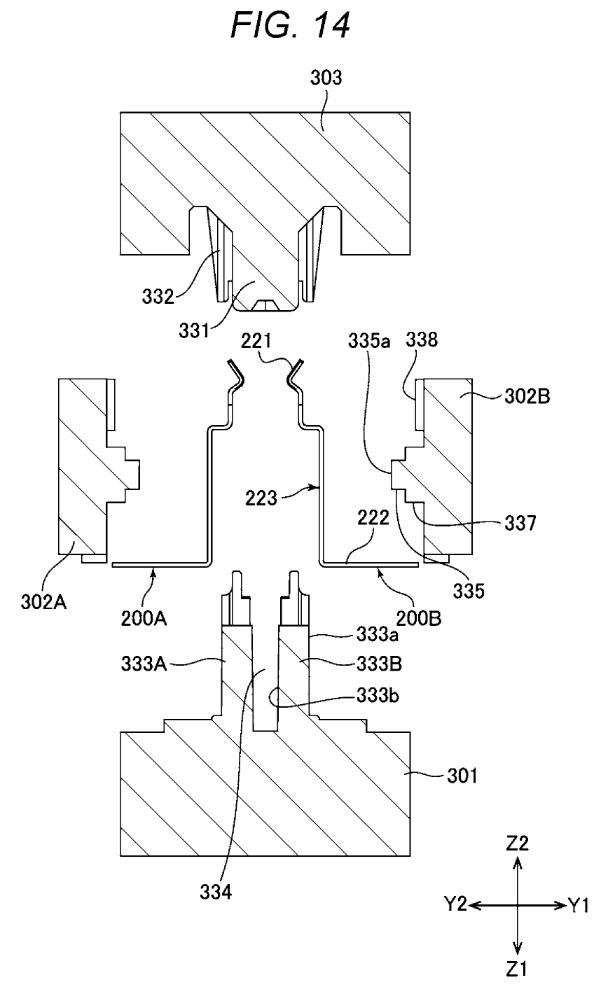

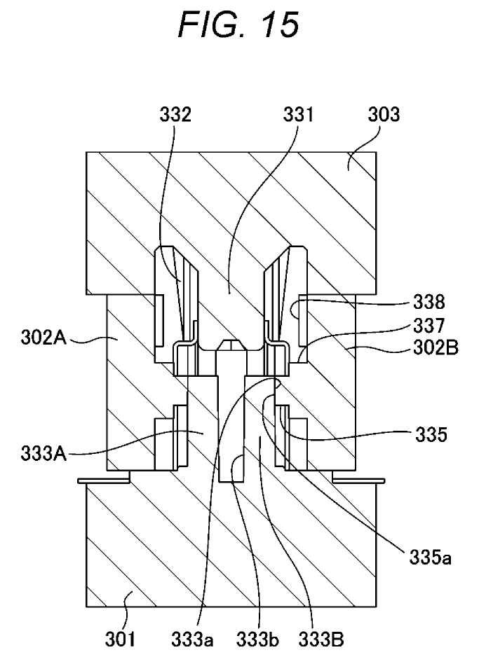

A method for manufacturing the receptacle connector 1 by insert molding will be described with reference to FIGS. 11 to 16. FIGS. 11 to 13 are cross-sectional views showing manufacturing processes at the same position as the cross section taken along line VI-VI of FIG. 5. FIGS. 14 to 16 are cross-sectional views showing manufacturing processes at the same position as the cross section taken along line X-X of FIG. 5.

First, a plurality of strip-shaped metal materials 200 connected to a carrier (not shown) are prepared by punching and bending a metal plate. By being connected to the carrier, the plurality of strip-shaped metal materials 200 are arranged adjacent to each other along the X direction. Each of these strip-shaped metal materials 200 finally becomes the terminal 2 of the receptacle connector 1.

More specifically, as shown in FIG. 11, FIG. 14, etc., one end 221 on the plug connector 5 side (Z2 side) in the Z direction forms the contact portion 21 of the terminal 2, and the other end 222 on the side opposite to the plug connector 5 (Z1 side) forms the mounting portion 22 of the terminal 2. Furthermore, an extension portion 223 extending along the Z direction between the one end 221 and the other end 222 forms the leg portion 23 of the terminal 2. The extension portion 223 has a first surface 223a, which is an X-Z plane, a second surface 223b, which is an X-Z plane, and a side surface 223c, which is a Y-Z plane.

Next, as shown in FIGS. 11, 12, 14, and 15, a plurality of molds 301 to 303 are installed for the strip-shaped metal materials 200.

First, the mold 301 is installed. The mold 301 is provided with two protrusions 333A and 333B protruding in the Z2 direction from the receptacle connector 1 side toward the plug connector 5 side and extending in the X direction. During molding of the resin, the protrusions 333A and 333B form the spaces 33A and 33B of the housing 3, respectively, and a space 334 between the protrusion 333A and the protrusion 333B forms the partition wall 34 of the housing 3.

The protrusions 333A and 333B each have two side surfaces 333a and 333b facing each other in the Y direction. The two side surfaces 333a and 333b are inclined so as to approach each other from the receptacle connector 1 side toward the plug connector 5 side. The mold 301 is installed for the plurality of strip-shaped metal materials 200 such that the protrusions 333A and 333B are arranged on the second surface 223b side (inner side) of the extension portion 223 of each of the strip-shaped metal materials 200 in the Y direction. In the present embodiment, the insertion direction in which the mold 301 is inserted coincides with the Z direction, but the insertion direction of the mold 301 does not have to coincide with the Z direction.

A groove 322 extending along the Y2 direction is provided near the root of the protrusion 333A. A groove 322 extending along the Y1 direction is provided near the root of the protrusion 333B. By providing these grooves 322, the other end 222 of the strip-shaped metal material 200 forming the mounting portion 22 of the terminal 2 is exposed to the outside.

Next, the mold 302 is installed. Molds 302A and 302B each include two convex portions 335 and 338. The convex portions 335 and 338 of the mold 302A protrude in the Y1 direction. The convex portions 335 and 338 of the mold 302B protrude in the Y2 direction.

The convex portion 335 further mainly includes a portion 339-1, a portion 339-2, and a portion 337 along the Y direction. During molding of the resin, the portion 339-1 forms the substantially trapezoidal cross-sectional portion 39-1 (see FIG. 10) of the through hole 35, the portion 339-2 forms the substantially rectangular cross-sectional portion 39-2 (see FIG. 10) of the through hole 35, and the portion 337 forms the recess 37 of the housing 3. The convex portion 338 forms the recess 38 of the housing 3.

In each of the molds 302A and 302B, a plurality of portions 339-1 are provided while being separated from each other along the X direction corresponding to the through holes 35. Furthermore, the portion 339-1 has a substantially trapezoidal shape in a cross section (X-Y plane) intersecting the Z direction, corresponding to the substantially trapezoidal cross-sectional portion 39-1 (see FIG. 10) of the through hole 35. In other words, the portion 339-1 has a shape that gradually expands toward the outside of the housing 3. Similarly, in each of the molds 302A and 302B, a plurality of portions 339-2 are provided while being separated from each other along the X direction corresponding to the through holes 35. Furthermore, the portion 339-2 has a substantially rectangular shape in a cross section (X-Y plane) intersecting the Z direction, corresponding to the substantially rectangular cross-sectional portion 39-2 (see FIG. 10) of the through hole 35. The portion 337 is provided as one rectangular parallelepiped shape extending in the X direction.

When installing the mold 302, the convex portion 335 is inserted from its tip 335a side between the extension portions 223 arranged at intervals in the X direction. Specifically, the convex portion 335 is inserted between the extension portions 223 along the Y direction from the first surface 223a side toward the second surface 223b side of the extension portion 223. At this time, the side surface (surface on the paper of FIG. 11) of the portion 339-2 of the convex portion 335 is arranged while facing the side surface 223c of the strip-shaped metal material 200 in the Y-Z plane. Furthermore, the tip 335a of the convex portion 335 is abutted against the side surface 333a of the protrusion 333 of the mold 301.

Finally, the mold 303 is installed. The mold 303 is installed so as to cover the one ends 221 of the plurality of strip-shaped metal materials 200 from the plug connector 5 side toward the receptacle connector 1 side (Z1 side). The mold 303 is provided with a central protruding portion 331 and side protruding portions 332. The side protruding portions 332 are symmetrically arranged so as to sandwich the central protruding portion 331 in the Y direction. The fitting hole 31 of the housing 3 is formed inside the side protruding portion 332 in the Y direction. A space 321 for accommodating the one end 221 of the strip-shaped metal material 200 is provided between the central protruding portion 331 and the side protruding portion 332. The mold 303 is installed so as to cover the one end 221 of the strip-shaped metal material 200 in a state of being accommodated in the space 321.

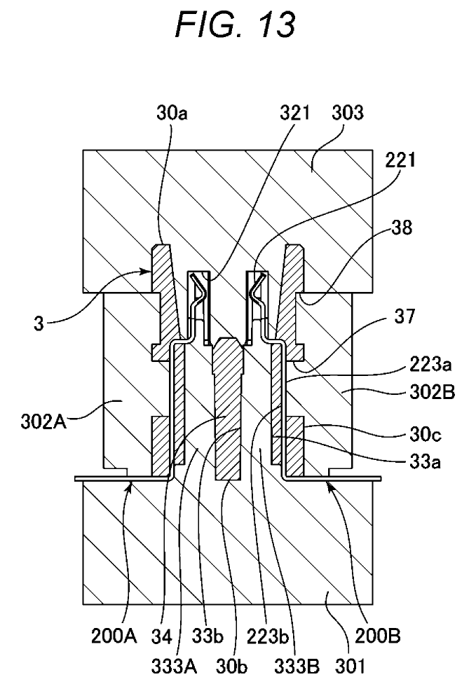

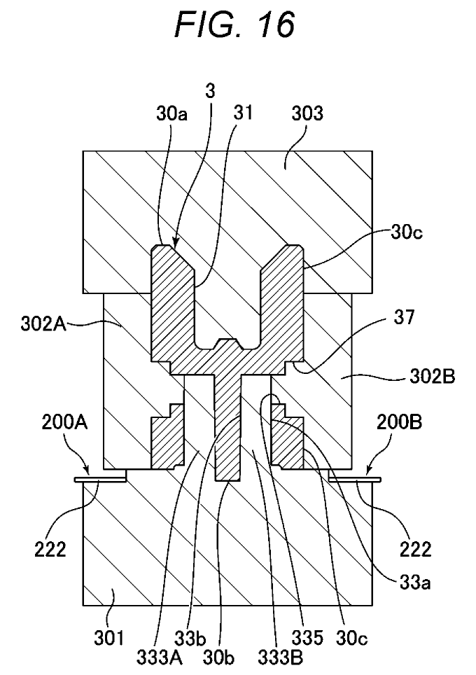

After installing the molds 301 to 303, resin is injected into the molds as shown in FIGS. 13 and 16. As a result, the strip-shaped metal material 200 is mounted to the housing 3 at a predetermined portion. As described above, the mold 302 is installed so that the tip 335a of the convex portion 335 abuts against the side surface 333a of the protrusion 333 of the mold 301. Therefore, the resin does not flow into the abutted portion. As a result, the spaces 33A and 33B and the plurality of through holes 35 communicate with each other inside the housing 3. Furthermore, the mold 302 is installed such that the side surface (surface on the paper of FIG. 11) of the portion 339-2 of the convex portion 335 is arranged while facing the side surface 223c of the strip-shaped metal material 200 in the Y-Z plane. Therefore, even if a strong force acts due to the flow of the resin during the injection of the resin, the strip-shaped metal material 200 does not move by the force. As a result, since the distance between the extension portions 223 in the X direction is maintained at a predetermined length, no deviation occurs in the pitch between the terminals in the resulting connector.

Since a slight gap is formed between the side surface (surface on the paper of FIG. 11) of the portion 339-2 of the convex portion 335 and the side surface 223c of the strip-shaped metal material 200, the resin flows into the gap during the injection of the resin. As a result, at least the portion 23c-1 of the side surface 23c of the terminal 2 (portion of the side surface 23c on the second surface 23b side) is covered with the resin (see FIG. 10). On the other hand, since the resin hardly adheres to the portion of the side surface 223c on the first surface 223a side, the portion 23c-2 of the side surface 23c of the terminal 2 (portion of the side surface 23c on the first surface 23a side) becomes thin or is exposed to the outside.

After the resin injected into the mold cools and solidifies to form the housing 3, the molds 301 to 303 are removed from the housing 3 and the strip-shaped metal material 200. As described above, the side surfaces 333a and 333b of the protrusions 333A and 333B are inclined so as to approach the side of the surface 33a of the housing 3 mounted to the second surface 23b of the leg portion 23 from the receptacle connector 1 side toward the plug connector 5 side (Z2 side). Furthermore, the portion 339-1 of the convex portion 339 has a shape that gradually expands toward the outside of the housing 3 in the cross section (X-Y plane) intersecting the Z direction. With such a configuration, the mold removal work of the molds 301 and 302 can be easily performed.

Finally, the receptacle connector 1 is completed by separating the strip-shaped metal material 200 from the carrier.

The order of installation of the molds 301 to 303 may be changed as appropriate. For example, the mold 302, the mold 301, and the mold 303 may be installed in this order.

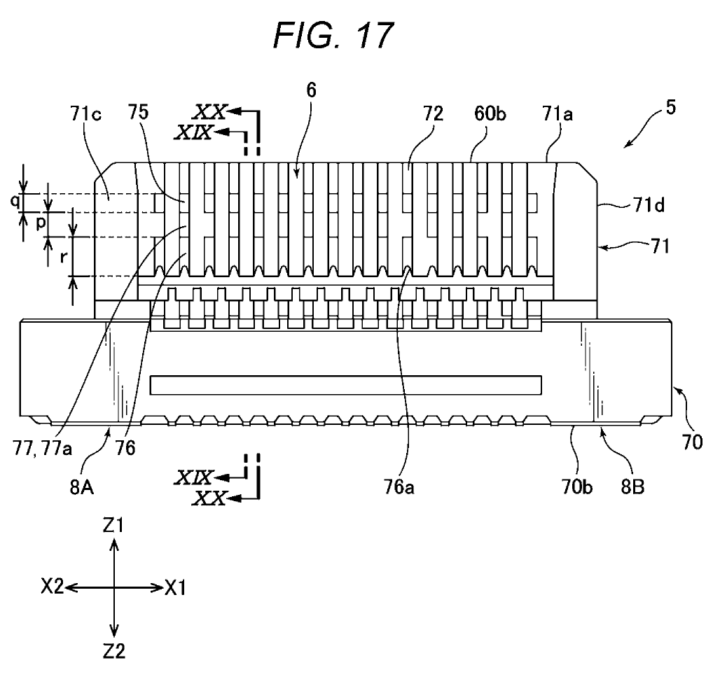

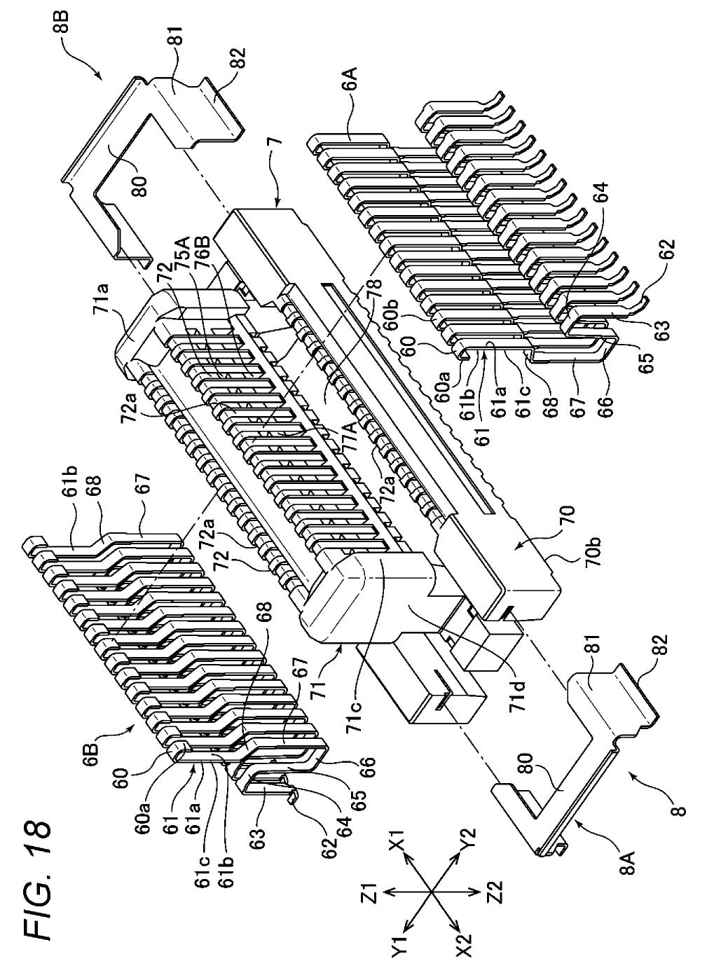

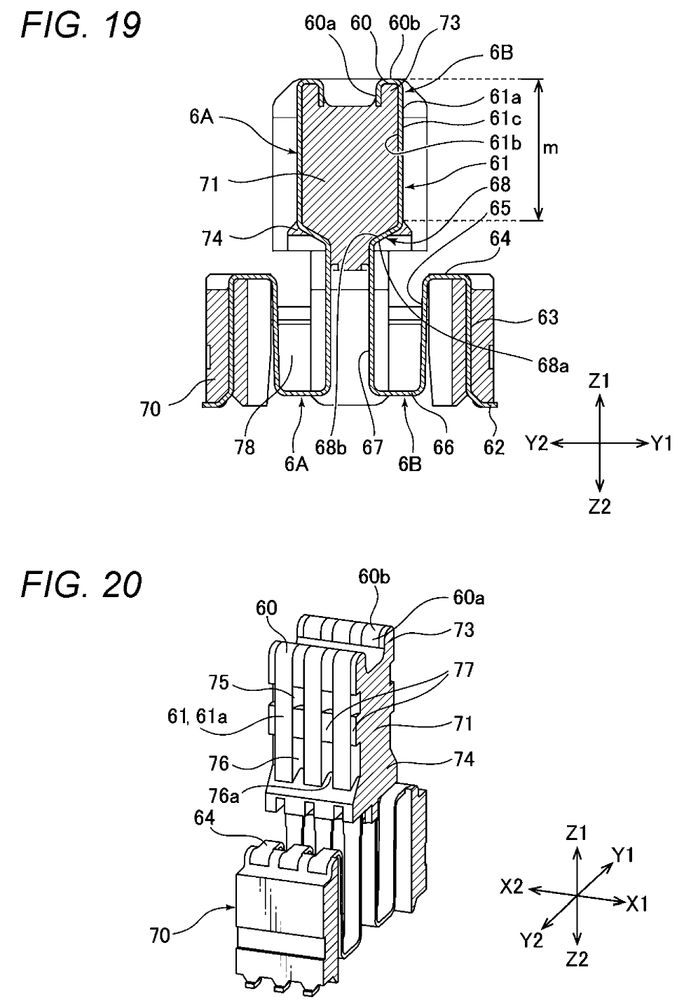

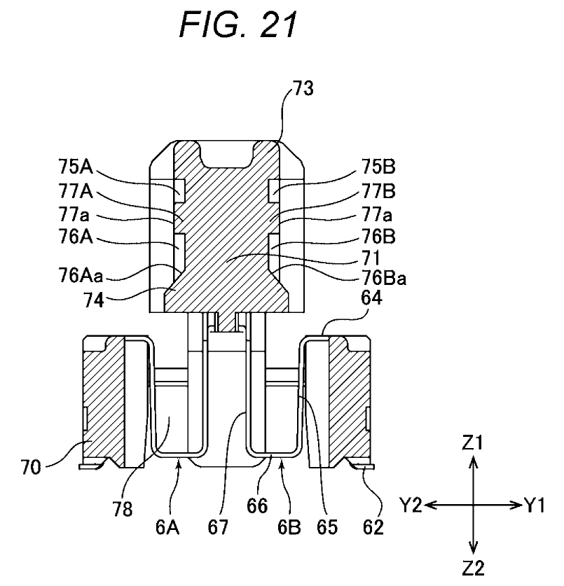

FIG. 17 shows a front view of the plug connector. FIG. 18 is an exploded perspective view of FIG. 17. FIG. 19 is a cross-sectional view taken along line XIX-XIX of FIG. 17. FIG. 20 is a perspective view in a cross section taken along line XX-XX of FIG. 17. FIG. 21 is a cross-sectional view taken along line XX-XX of FIG. 17.

Like the receptacle connector 1, the plug connector 5 has a symmetrical shape in each of the X direction and the Y direction. In the following description and drawings, when it is convenient to distinguish between a member on the Y1 side (front side) and a member on the Y2 side (rear side) in the Y direction, letters “A” and “B” are added in addition to reference numerals.

The plug connector 5 includes a resin housing 7, a plurality of terminals 6 mounted (held) to the housing 7 by insert molding, and two fixing metal fittings 8. At least a part of each of the terminal 6 and the fixing metal fitting 8 is mounted to the housing 7 by insert molding. FIG. 18 is a drawing assuming that the terminals 6 and the fixing metal fittings 8 could be removed from the housing 7 for convenience of explanation.

Like the terminal 6, the fixing metal fitting 8 is formed by punching and bending a metal plate, and includes a base portion 80, a leg portion 81, and a mounting portion 82. Since the fixing metal fitting 8 is similar to the fixing metal fitting 4 of the receptacle connector 1, detailed description thereof will be omitted.

The housing 7 includes a main body 70 and a movable portion 71. The main body 70 forms a frame shape together with the base portion 80, which is a part of the fixing metal fitting 8, in an X-Y plane orthogonal to the Z direction, which is the connection direction of the receptacle connector 1 and the plug connector 5, and the main body 70 has a hole 78 in the center. The movable portion 71 has a substantially rectangular shape as a whole, and is positioned substantially at the center of the hole 78 of the main body 70 in the X-Y plane.

The plurality of terminals 6 all have the same shape and structure, and are arranged adjacent to each other with the X direction as the terminal arrangement direction. Like the terminal 2 of the receptacle connector 1, the plurality of terminals 6 are formed by punching and bending a single metal plate.

The terminal 6 extends in the Z direction, which is the connection direction, as a whole. A contact portion 61 (extension portion) is provided on the Z1 side of the terminal 6. Furthermore, a mounting portion 62 is provided on the Z2 side of the terminal 6. Specifically, the contact portion 61 mounted (fixed) to the movable portion 71 is provided on one end side in the Z direction of the terminal 6, and the mounting portion 62 fixed to the main body 70 is provided at the other end.

The contact portion 61 extends along the Z direction between a first fixing portion 60 and a second fixing portion 68. The contact portion 61 has a first surface 61a, which is a surface extending in the X direction and the Z direction, and a second surface 61b facing the first surface 61a in the Y direction. The first surface 61a is an outer surface in the Y direction among X-Z surfaces of the contact portion 61. The second surface 61b is an inner surface in the Y direction among the X-Z surfaces of the contact portion 61. That is, the first surface 61a faces the outside of the housing 7, and the second surface 61b faces the inside of the housing 7.

The first surface 61a of the contact portion 61 is a surface that comes into contact with the terminal 2 of the receptacle connector 1. In the present embodiment, the entire first surface 61a is exposed to the outside of the housing 7. Furthermore, at least a part of the contact portion 61 other than the exposed first surface 61a is mounted to the housing 7 by insert molding.

The first surface 61a is formed in the same plane as the first surface 61a of the contact portion 61 adjacent in the X direction. Furthermore, all the first surfaces 61a of the contact portions 61 exposed to the outside are formed in the same X-Z plane (at the same position in the Y direction).

The first fixing portion 60 is located on the receptacle connector 1 side (Z1 side) in the Z direction. An end portion 60a of the first fixing portion 60 is embedded in the housing 7 while being folded back at a substantially right angle toward the plug connector 5 side (Z2 side) in the Z direction. A housing portion 73 is provided at an end portion on the Z1 side of the housing 7, and the end portion 60a is fixed to the movable portion 71 by being embedded in the housing portion 73.

The second fixing portion 68 is located on the side opposite to the receptacle connector 1 side (Z2 side) in the Z direction, and is formed as an inclined portion formed by bending an end portion on the Z2 side of the contact portion 61 inward. The second fixing portion 68 has a first surface 68a and a second surface 68b, the first surface 68a faces outward in the Y direction, and the second surface 68b faces the first surface 68a and faces inward in the Y direction. The first surface 68a and the second surface 68b are mounted to the housing 7. Specifically, the second fixing portion 68 is fixed to the movable portion 71 by a housing portion 74 or the like of the housing 7.

The mounting portion 62 is a portion mounted on the substrate, and extends in parallel with the substrate along the Y direction toward the outside of the housing 7.

Between the mounting portion 62 and the second fixing portion 68, a vertical portion 63, a horizontal portion 64, a vertical portion 65, a horizontal portion 66, and a vertical portion 67 are provided in this order.

A part of the vertical portion 63 and a part of the horizontal portion 64 are fixed to the main body 70 together with the mounting portion 62. On the other hand, the vertical portion 65, the horizontal portion 66, and the vertical portion 67 elastically connect the horizontal portion 64 fixed to the main body 70 and the second fixing portion 68 fixed to the movable portion 71 without being connected to either the main body 70 or the movable portion 71. As a result, the movable portion 71 functions as a floating portion. The movable portion 71 is capable of floating mainly in the X direction and the Y direction. Since the movable portion 71 functions as a floating portion, it is possible to allow misalignment occurring when connecting the receptacle connector 1 and the plug connector 5.

The movable portion 71 includes a top surface 71a, a side surface 71c, and a side surface 71d. The top surface 71a is a top surface located on the receptacle connector 1 side (Z1 side) in the Z direction. The side surface 71c is a side surface extending in the X direction and the Z direction, and the side surface 71d is a side surface extending in the Y direction and the Z direction.

The main body 70 includes a bottom surface 70b located on the opposite side (Z2 side) of the top surface 71a. In the present embodiment, the direction in which the side surface 71c extends coincides with the X direction, which is the arrangement direction of the terminals 6, but the direction in which the side surface 71c extends does not have to coincide with the X direction.

On the top surface 71a, a top portion 60b of the first fixing portion 60 is exposed to the outside of the housing 7. The top portion 60b exposed to the outside forms the same surface as the top surface 71a in the X-Y plane orthogonal to the Z direction, and forms a top portion of the plug connector 5 together with the housing 7.

The side surface 71c is provided with a plurality of walls 72 protruding outward along the Y direction. A groove 72a along the Z direction is formed between the walls 72 adjacent to each other in the X direction. Each terminal 6 is installed in one of the grooves 72a.

Between the contact portions 61 of the terminals 6 adjacent to each other in the X direction, a recess 75 and a recess 76 are provided along the Z direction. The recesses 75 adjacent to each other in the X direction and the recesses 76 adjacent to each other in the X direction are provided while being separated from each other by the same predetermined distance G in the X direction. Furthermore, the recess 75 and the recess 76 are provided while being separated from each other in the Z direction, the recess 75 is arranged on the Z1 side, and the recess 76 is arranged on the Z2 side.

The recess 75 and the recess 76 have lengths over predetermined ranges q and r (first predetermined range), respectively, along the Z direction. The recesses 75 and 76 are recessed into the inside of the housing 7 along the Y direction from the exposed first surface 61a side toward the second surface 61b side facing the first surface 61a.

In the present embodiment, the recess direction in which the recesses 75 and 76 are recessed coincides with the Y direction, which is the depth direction, but the recess direction of the recesses 75 and 76 does not have to coincide with the Y direction.

The recesses 75 and 76 are formed through the same manufacturing process as the through hole 35 of the receptacle connector 1. Therefore, the contact portions 61 are separated from each other by the predetermined distance G defined by the plurality of recesses 75 and 76 in the X direction. As a result, similarly to the receptacle connector 1, the plug connector 5 in which the deviation of the pitch between the terminals is suppressed can be configured.

The predetermined distance G is preferably set to be slightly longer than the length of the recesses 75 and 76 in the terminal arrangement direction (opening length of the recesses 75 and 76). In other words, the length of the recesses 75 and 76 in the terminal arrangement direction (opening length of the recesses 75 and 76) is preferably set to be slightly shorter than the predetermined distance G. By setting in this way, it becomes possible to mount the side surface 61c of the contact portion 61 to the housing 7. Furthermore, the contact portions 61 adjacent to each other in the terminal arrangement direction can be arranged so as to be separated from each other by a predetermined distance longer than the length of the recesses 75 and 76 in the terminal arrangement direction.

Similarly to the cross section (X-Z plane) of the through hole 35 provided in the receptacle connector 1, at least a part of a cross section (X-Z plane) of the recesses 75 and 76 intersecting the Y direction is preferably set to gradually and/or stepwise decrease as it goes into the inside of the housing 7 from the exposed first surface 61a side toward the second surface 61b side. With such a configuration, the mold removal work can be facilitated.

In the present embodiment, on the inner side of the housing 7 (second surface 61b side), the dimension of the recesses 75 and 76 in the X direction is set to gradually decrease as it goes into the inside of the housing 7. Furthermore, in a portion 76a of the recess 76 on the receptacle connector 1 side (Z2 side) in the Z direction, the dimension of the recess 76 in the Z direction in addition to the X direction is also set to gradually decrease as it goes into the inside of the housing 7. Note that the dimensions of the recesses 75 and 76 may be set to gradually decrease as they go into the inside of the housing 7 in either the X direction or the Z direction.

Furthermore, similarly to the through hole 35 provided in the housing 3 of the receptacle connector 1 (see FIG. 10), the shape of the recesses 75 and 76 in the cross section (X-Y plane) intersecting the Z direction may be substantially trapezoidal, or the first surface 61a side of the cross section may be substantially rectangular.

A portion over the ranges q and r in the contact portion 61 is mounted to the housing 7 on the second surface 61b. Furthermore, the portion over the ranges q and r in the contact portion 61 is mounted to the housing 7 at the side surface 61c of the contact portion 61, particularly on the second surface 61b side in the Y direction. In other words, the second surface 61b of the contact portion 61 is mounted to the housing 7 at least in the ranges q and r (first predetermined range). Furthermore, at least a portion of the side surface 61c on the second surface 61b side is mounted to the housing 7 at least in the ranges q and r (first predetermined range).

On the other hand, the first surface 61a side of the side surface 61c may be in a state where the resin of the housing 7 is thinner than the second surface 61b side of the side surface 61c due to the relationship with the cross section (X-Z plane) of the recesses 75 and 76 described above. Furthermore, the first surface 61a side of the side surface 61c may be exposed to the outside.

The entire first surface 61a of the contact portion 61 is exposed to the outside of the housing 7, and is not supported by the resin of the housing 7. Therefore, in the ranges q and r where the recesses 75 and 76 are provided, the mounting of the contact portion 61 to the housing 7 may become fragile.

In order to reinforce the mounting of the contact portion 61 to the housing 7, a bridge portion 77 is provided along the Z direction. The bridge portion 77 only needs to be configured to reinforce the fragility of the contact portion 61 with respect to the housing 7 due to the provision of the recesses 75 and 76. As an example of the bridge portion 77, in the present embodiment, the bridge portion 77 is formed along the Z direction between the contact portions 61 of the terminals 6 adjacent to each other in the X direction using the resin of the housing 7. The resin constituting the bridge portion 77 is filled on the first surface 61a side (outside in the Y direction) with respect to the recesses 75 and 76 along the Z direction in the Y direction, and connects the side surfaces 61c of the plurality of terminals 6 to each other in the X direction. Therefore, the contact portion 61 is more securely mounted to the housing 7.

The bridge portion 77 has a length over a predetermined range p (second predetermined range) along the Z direction. In the range p, the second surface 61b of the contact portion 61 is mounted to the housing 7. In addition, in the range p, the side surfaces 61c of the adjacent contact portions 61 are connected to each other in the X direction by the bridge portion 77. That is, the second surface 61b and the side surface 61c of the contact portion 61 are mounted to the housing 7 in the range p.

The resin constituting the bridge portion 77 does not have to be filled up to the same plane as the first surface 61a of the contact portion 61 adjacent in the X direction. That is, in the range p (second predetermined range), in addition to the second surface 61b of the contact portion 61, at least parts of the side surfaces 61c may be connected to each other in the X direction by the bridge portion 77 and mounted to the housing 7.

The resin constituting the bridge portion 77 may be filled up to the same plane as the first surface 61a of the contact portion 61 adjacent in the X direction. For example, a surface 77a, which is an outer surface of the bridge portion 77, may be formed in the same plane (at the same position in the Y direction) as the first surface 61a of the contact portion 61 adjacent in the X direction. In the case where the surface 77a of the bridge portion 77 and the first surface 61a of the contact portion 61 are formed in the same plane, the force applied to the contact portion 61 can be distributed to the bridge portion 77 when connecting the receptacle connector 1 and the plug connector 5, so that damage occurring in the contact portion 61 can be reduced. The bridge portion 77 is preferably arranged adjacent to the recesses 75 and 76 in the Z direction, and between the recess 75 and the recess 76. By providing the bridge portion 77 in the vicinity of the recesses 75 and 76, the mounting of the contact portion 61 to the housing 7 can be reinforced more effectively.

The present disclosure is not limited to the above-described embodiment, and various other modifications are possible. For example, instead of providing the through hole (hole) in the receptacle connector 1 as described above, a recess (concave portion) may be provided like the plug connector 5. Furthermore, in the present embodiment, as shown in FIG. 17, the range r is formed longer than the range q in the Z direction, but the range q may be formed longer than the range r. Alternatively, the range q and the range r may be formed to have the same length in the Z direction.

It should be understood that the above description relates to preferred embodiments and is merely representative of the article and the method for manufacturing the same. It can be appreciated that variations and modifications of different embodiments will be readily apparent to those skilled in the art in light of the above teachings. Accordingly, exemplary embodiments as well as alternative embodiments can be practiced without departing from the spirit of the article and method of the present disclosure.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A connector comprising:
a housing; and
a plurality of terminals held by the housing,
wherein the plurality of terminals are arranged in a terminal arrangement direction intersecting a connection direction with a mating connector, each of the plurality of terminals has one end, has another end on a side opposite to the one end in the connection direction, and has an extension portion extending in the connection direction between the one end and the other end,
the extension portion has a first surface extending in the terminal arrangement direction and the connection direction and facing outward, and a second surface facing the first surface,
at least a part of the first surface is exposed to the outside of the housing in a first predetermined range in the connection direction, at least a part of the extension portion other than the exposed first surface is mounted to the housing by insert molding,
the housing has a plurality of through holes or a plurality of recesses, and
the plurality of through holes or the plurality of recesses are provided between the extension portions adjacent to each other in the terminal arrangement direction in a second predetermined range included in the first predetermined range, and extend into the inside of the housing.

2. The connector according to claim 1, wherein the extension portions adjacent to each other in the terminal arrangement direction are separated from each other by a predetermined distance longer than a length of the plurality of through holes or the plurality of recesses in the terminal arrangement direction.

3. The connector according to claim 1, wherein the housing further has a space, and
the space extends from a bottom surface of the housing toward the inside of the housing in the connection direction and communicates with the plurality of through holes inside the housing.

4. The connector according to claim 1, wherein the first surface is a surface extending in the terminal arrangement direction and the connection direction, and the first surfaces of the extension portions adjacent to each other in the terminal arrangement direction are formed at the same position in a direction intersecting the terminal arrangement direction and the connection direction.

5. The connector according to claim 4, wherein the first surface is located outside in the direction intersecting the terminal arrangement direction and the connection direction with respect to a surface of the housing adjacent to the extension portion in the terminal arrangement direction.

6. The connector according to claim 1, wherein the one end is a contact portion formed as a free end, and the other end is a mounting portion fixed to the housing, and
a plurality of terminal groups each including the plurality of terminals are provided to be separated from each other in a direction intersecting the terminal arrangement direction and the connection direction.

7. The connector according to claim 1, wherein the second surface is mounted to the housing at least in the second predetermined range.

8. The connector according to claim 1, wherein a portion of a side surface of the extension portion at least on a side of the second surface is mounted to the housing at least in the second predetermined range.

9. The connector according to claim 1, wherein the second surface and a side surface of the extension portion are mounted to the housing within the first predetermined range and outside the second predetermined range.

10. The connector according to claim 1, wherein at least a part of the first surface is mounted to the housing outside the first predetermined range, or
at least a part of the second surface and at least a part of a side surface of the extension portion are mounted to the housing outside the first predetermined range.

11. The connector according to claim 1, wherein the second predetermined range in the connection direction has the same size as the first predetermined range.

12. The connector according to claim 1, wherein a cross section of the plurality of through holes or the plurality of recesses intersecting a direction from the first surface toward the second surface is formed to gradually or stepwise decrease, or formed to gradually and stepwise decrease as the through hole or the recess goes toward the inside of the housing.

13. The connector according to claim 12, wherein a shape of the cross section of the plurality of through holes or the plurality of recesses intersecting the connection direction is substantially trapezoidal.

14. The connector according to claim 13, wherein a shape of the cross section of the plurality of through holes or the plurality of recesses intersecting the connection direction on a side of the first surface is substantially rectangular.

15. The connector according to claim 3, wherein a cross section of the space intersecting the connection direction is formed to gradually or stepwise decrease, or formed to gradually and stepwise decrease as the space goes from the bottom surface of the housing toward the inside of the housing.

16. A connector assembly comprising:
the connector according to claim 1; and
a mating connector configured to be connectable to the connector.

17. A method for manufacturing a connector by insert molding, comprising:
preparing a plurality of strip-shaped metal materials arranged adjacent to each other in a terminal arrangement direction intersecting a connection direction with a mating connector by being connected to a carrier, the plurality of strip-shaped metal materials each having one end, another end provided on a side opposite to the one end in the connection direction, and an extension portion provided between the one end and the other end and extending in the connection direction;
inserting a convex portion provided in a first mold between the extension portions in a direction from a first surface facing outward in the extension portion to a second surface facing the first surface;
installing a second mold to cover the one end in a direction from the mating connector to the connector;
injecting resin into the first mold and the second mold;
removing the first mold and the second mold; and
separating the plurality of strip-shaped metal materials from the carrier.

18. The method for manufacturing a connector according to claim 17, wherein the first surface extends in an arrangement direction of the plurality of strip-shaped metal materials and the connection direction.

19. The method for manufacturing a connector according to claim 17, further comprising:
after preparing the plurality of strip-shaped metal materials and before inserting the convex portion provided in the first mold between the extension portions, installing a third mold such that a protrusion provided in the third mold and protruding in a direction from the connector to the mating connector is arranged on an inner side of the extension portion of each of the plurality of strip-shaped metal materials in a direction from the first surface to the second surface; and
when inserting the convex portion provided in the first mold between the extension portions, abutting a tip of the convex portion against a side surface of the protrusion of the third mold.
